(19) United States
(12) Patent Application Publication
(10) Pub. No.: US 2010/0021316 A1
(43) Pub. Date: Jan. 28, 2010

(54) Pump device

(76) Inventor: Kaj Pelamo, Veikkola (FI)

Correspondence Address: JOEL D. SKINNER, JR.;SKINNER AND ASSOCIATES, 212 COMMERCIAL ST., HUDSON, WI, 54016, US

(21) Appl. No.: 12/311,765

(22) PCT Filed: Oct. 8, 2007
(86) PCT No.: PCT/FI2007/000241

§ 371 Date: Apr. 27, 2009

(30) Foreign Application Priority Data
Oct. 11, 2006 (FI) 20060899

(51) Int. Cl. F04B 53/16; F04B 49/00; B67D 7/62

(52) U.S. Cl. 417/63; 137/565.01

(57) ABSTRACT

Pump device, particularly a dosing pump, which is intended for dosing at least one liquid substance by sucking the liquid along a suction hose/pipe (6) from one point to the pump (10) and feeding the liquid along an outlet pipe/hose (13) to another point. The pump device is located in a case (15), in which as an essential component there is a connector, particularly threads (7, 8) to at least one barrel/canister equipped with standard threads.

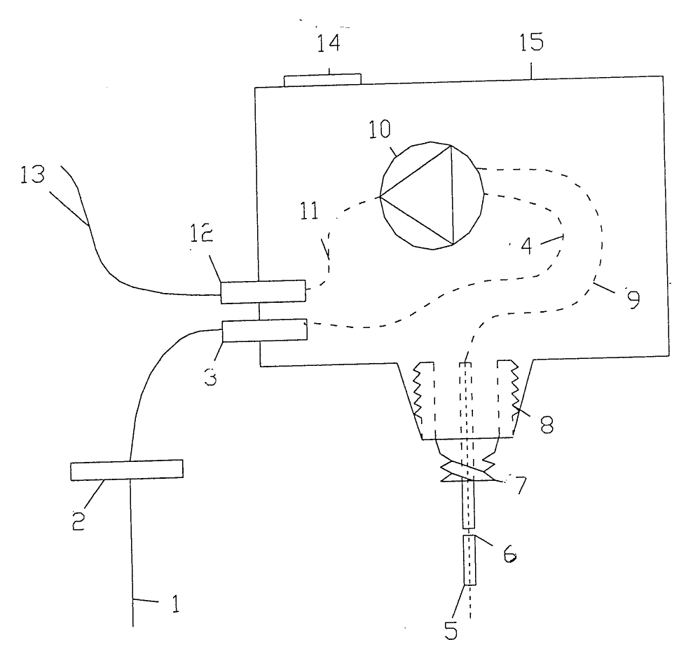

The present invention relates to a pump device and more specifically to a programmable pump device, which can be connected to an external source containing liquid.

Very many different kinds of pumps are known for many different purposes. There are large pumps and small pumps, the operating principle of which always varies according to their application. Membrane pumps, which are often used for dosing liquid substances, are also known. The field of the present invention is precisely a dosing pump.

The dosing of substances is often performed from tanks of canisters. One way is to empty the tank or canister into a dosing tank, to which a pump is permanently connected. Another way is to connect the pump in a suitable manner to the tank or canister, in which the liquid to be dosed has been delivered to the dosing facility. The connection is often a problem, as there are no devices on the market that would suit a good and tight connection. This results in extra work, unreliable apparatuses, and other harms.

The present invention is intended to create a pump device, which solves this problem and creates a pump apparatus that can be connected rapidly to standard transportation tanks and canisters, which can be installed wherever specifically a dosing pump is required.

The aforementioned advantages and benefits of the present invention are achieved in the manner described as characteristic in the accompanying Claims.

In the following, the invention is examined in greater detail with reference to the accompanying schematic drawing, which shows the principle of the invention.

Thus, the FIGURES show schematically the pump device, which is formed of the necessary components packed in a case 15. The most important of these components is naturally the pump itself, which in the FIGURE is marked with the reference number 10.

The case 15 includes a connector component, which is used to connect the pump device tightly and quickly to a barrel equipped with standard threads. These connector threads are marked with the reference number 7. As such, the size of the barrel is of no importance, however, in certain types of barrel plugs are used, which are supported on internal threads in the lid of the barrel. Using the threads 7, the plug can be replaced with a pump device according to the invention.

In the case of smaller vessels and products packed in canisters standard threads very often are used in these too. Here, however, the cork is screwed shut onto a collar with an external thread. The internal threads, marked with the reference number 8, in the device according to the invention, correspond to the threads of the plug of the canister, so that screwing the pump device according to the invention onto the canister is one way to ensure a rapid and certain attachment.

In the FIGURE, the thread components 7 and 8 are marked as a permanent part of the pump device. The thread component can, however, be separated to form a structure that is, as such, known, in which the attachment can be made by rotating only the connector component and not the entire device, so that the final attachment of the device takes place in connection with the tightening of the threads.

In the FIGURE, the suction pipe is marked with the reference number 6. The suction pipe can be only a pipe, or, if desired, a separate protector pipe can be used around the suction pipe. Reference number 5 symbolizes a sensor, which detects the height of the surface level. This is used when it is wished to give a signal that the tank is emptying and must be changed.

Inside the device, the liquid sucked by the pump 10 travels along the hose/pipe 9 and exits from the pump along the hose/pipe 11 to the outlet connector 12 and from there along the outlet pipe/hose 13 to the desired location.

If it is wished to use the pump device according to the invention for the combined feed of at least two substances, the device according to the invention can be equipped with additional inlet systems. Such is shown by the suction hose/pipe marked with the reference number 1, which runs through the tank's schematically shown cork 2 to the inlet connection 3, from there along the device's internal hose/pipe to the pump 10 and on, mixing the content of the outlet pipe.

The pump device according to the invention is a totality that is specifically electrically operated and especially equipped with programmable operation. In the FIGURE, a display is marked with the reference number 14. In addition to this, on the surface of the device comprising the display there is a keyboard, from which the desired functions can be activated. Such functions are, for example, the feed rate, settings for intermittent or continuous feed, the feed quantity of the substance, and various alarms and similar functions.

The programming of the device is not dealt with here in greater detail, because by means of modem technology it can be carried out to meet the desired requirements.

The device according to the invention can be assembled in a neat case of quite small size, which is well protected from external factors, in which in basic use the only external components are the protruding feed hose and the power cable. In certain conditions, the power cable too can be replaced with a battery. Thus the device according to the invention is suitable for use even in demanding industrial conditions, without immediate danger of being damaged.

1. Pump device, particularly a dosing pump, which is intended for dosing at least one liquid substance by sucking the liquid along a suction hose/pipe (6) from one point to the pump (10) and feeding the liquid along an outlet pipe/hose (13) to another point, characterized in that the pump device is located in a case (15), in which as an essential component there is a connector, particularly both internal threads (8) and external threads (7) for connection to a barrel/canister connector equipped with two different kinds of threads.

2. Pump device according to claim 1, characterized in that the device also includes at least a second inlet line (1-4) for sucking a second substance.

3. Pump device according to claim 1 or 2, characterized in that there is a display (14) in the device, as well as function keys for selecting its functions.
